(19) United States
(12) Patent Application Publication
(10) Pub. No.: US 2017/0282320 A1
(43) Pub. Date: Oct. 5, 2017

(54) MODULE FOR DETECTING CONTACT BETWEEN OBJECT TO BE PROCESSED AND PRECISION TOOL TIP AND METHOD FOR DETECTING CONTACT USING SAME

(71) Applicant: Korea Institute of Industrial Technology, Chungcheongnam-do (KR)

(72) Inventors: Young Jae CHOI, Seoul (KR); Ki Hyeong SONG, Ansan-si, Gyeonggi-do (KR); Hon Jong CHOI, Seoul (KR); Bo Hyun KIM, Suwon-si, Gyeonggi-do (KR); Dong Yoon LEE, Seoul (KR)

(21) Appl. No.: 15/511,771

(22) PCT Filed: Oct. 30, 2014
(86) PCT No.: PCT/KR2014/010291

§ 371 Date: Mar. 16, 2017

(30) Foreign Application Priority Data
Sep. 18, 2014 (KR) 10-2014-0124445

(51) Int. Cl. B23Q 17/22; B23B 5/12

(52) U.S. Cl. CPC B23Q 17/2241; B23B 5/12

(57) ABSTRACT

A contact detection module includes a first conductive layer applied to an area of a precision tool tip that processes an object when in contact therewith. A conductive unit of the module includes a first conductive line connected to the object, through which an electric signal flows, and a second conductive line connected to the first conductive layer, through which the electric signal flows. A detection unit of the module includes a signal generation unit to supply the electric signal to at least one of the first and second conductive lines. A detection unit in the conductive unit detects whether the electric signal flows through the entire conductive unit, and determines whether the object and the precision tool tip are in contact with each other, in the lathe wherein the object is cut, based on a change in the electric signal detected.

### TECHNICAL FIELD

The present invention relates to a contact detection module for detecting contact between an object to be processed and a precision tool tip and a method for detecting contact using the same, and to a contact detection module that has a separate conductive layer provided at a distal end of a precision tool tip for processing an object to be processed and determines whether an object to be processed and a precision tool tip are in contact with each other, by detecting an electrical signal varied depending on whether the conductive layer and the object to be processed are in contact with each other, and a method for detecting contact using the same.

### BACKGROUND ART

A shelf is widely used to process a roll mold for manufacturing a prism sheet which is one of components of a backlight unit (BLU) inserted into a display product. In particular, because a pattern formed on an outer peripheral surface of the roll mold used for processing the prism sheet is fine, precise processing is required.

A precision tool tip for forming fine patterns in nano-units is used in the shelf on which a precise pattern is formed in such a roll mold.

However, it is difficult to observe such a tip used in fine precise processing through a sight of a user, and accordingly, there is a problem in that it is difficult to determine whether a mold to be processed and a precision tool tip are in contact with each other.

Accordingly, in the past, a technology of determining a location of a distal end of a tip simply using light or a microscope or determining a contact state of a precision tool tip, by measuring a load generated by contact between a tip and a mold in a state in which a separate piezoelectric sensor is provided in the tip was developed.

However, whether the tip and the mold are in contact with each other could be determined only when the tip processes an object to be processed, and accordingly, because an error corresponding to a processed depth is generated, an error occurs in accurate zero-point location setting of the precision tool tip.

Further, there is a problem in that when whether the mold and the tip are in contact with each other is determined using a load applied to the tip through the piezoelectric sensor, it is difficult to substantially detect very fine cutting loads when the tip and the mold are in contact with each other, and thus this technology may not be applied to ultra-precision micro machining.

That is, the conventionally-developed method of setting an initial location of a tip by detecting contact between a mold and the tip has a problem in that a large error occurs even when the method is applied to the ultra-precision micro machining, and thus, it is required to develop a technology for solving the problem.

### DISCLOSURE

### Technical Problem

The present invention is conceived to solve problems of a module for detecting contact between an object to be processed and a precision tool tip, which are used in the related art, and an aspect of the present invention is to provide a contact detection module for an object to be processed and a precision tool tip, which detects contact between the object to be processed and the precision tool tip through changes in detected electric signals, by transmitting the electric signals along conductive lines, in a state in which a conductive layer is applied to the precision tool tip and the conductive lines are connected to the object to be processed and the conductive layer, respectively.

### Technical Solution

To solve the above problems, a contact detection module for detecting whether a precision tool tip and an object to be processed are in contact with each other in a lathe in which the object to be processed is cut using the precision tool tip, according to an aspect of the present invention, includes: a first conductive layer applied to an area of the precision tool tip, which performs processing while being at least in contact with the object to be processed; a conductive unit including a first conductive line connected to the object to be processed, through which an electric signal flows, and a second conductive line connected to the first conductive layer, through which the electric signal flows; and a detection unit including a signal generation unit configured to supply the electric signal to at least one of the first conductive line and the second conductive line and a detection unit provided in the conductive unit to detect whether the electric signal flows through the entire conductive unit, and configured to determine whether the object to be processed and the precision tool tip are in contact with each other, based on a change in the electric signal detected by the detection unit.

Further, the contact detection module further includes a second conductive layer which is applied to one surface or an entire surface of the object to be processed, which is to be processed, and through which the electric signal flows when the second conductive layer is in contact with the first conductive layer.

Further, the second conductive layer is formed only in an area of the object to be processed, which is in contact with the precision tool tip.

Further, the second conductive layer is formed of the same material as that of the first conductive layer.

Further, the first conductive layer and the second conductive layer are removed by mutual friction when the object to be processed is cut by the precision tool tip.

Further, the first conductive layer is applied only to an area of the precision tool tip, which is in contact with the object to be processed.

Meanwhile, to solve the above problems, a contact detection method for detecting whether a precision tool tip and an object to be processed are in contact with each other in a lathe in which the object to be processed is cut using the precision tool tip, according to another aspect of the present invention, includes: coating a first conductive layer through which an electric signal flows, to a surface of the precision tool tip; installing a separate conductive unit connected to the first conductive layer and the object to be processed to transfer an electric signal; transferring the electric signal to at least one of the object to be processed and the first conductive layer; allowing the precision tool tip to approach the object to be processed; detecting a change in the electric signal detected by sequentially passing through the first conductive layer and the object to be processed, by the conductive unit; and determining whether the precision tool tip and the object to be processed are in contact with each other, based on the change in the electric signal detected by the conductive unit.

Further, the first conductive layer is applied only to an area of the precision tool tip, which is in contact with the object to be processed.

Further, the conductive unit includes: a first conductive line connected to the object to be processed, through which the electric signal flows; and a second conductive line connected to the first conductive layer, through which the electric signal flows.

Further, the contact detection method further includes coating a second conductive layer through which the electric signal flows, to the object to be processed.

### Advantageous Effects

To solve the problems, the present invention has the following effects.

First, there is an advantage in that in a state in which a distal end of a precision tool tip for performing cutting while being in contact with an object to be processed is coated with a first conductive layer and a conductive unit is connected to the first conductive layer and the object to be processed, an electric signal is transmitted and a change in a received electric signal is measured, so that whether the object to be processed and a precision tool tip are in contact with each other may be identified even without visual observation.

Second, there is an advantage in that a processing area of the object to be processed, which is in contact with the precision tool tip, is coated with a second conductive layer, so that whether the precision tool tip and the object to be processed may be detected even when the object to be processed is not formed of a conductive material.

Third, there is an advantage in that when the object to be processed and the precision tool tip are in contact with each other, an electric signal is generated, so that the precision tool tip and the object to be processed automatically come into contact with each other using an electric signal generated without manipulation of a user as a trigger.

Effects of the present invention are not limited to the above-described effects, and other not-mentioned effects could be clearly understood by those skilled in the art with reference to the appended claims.

### BRIEF DESCRIPTION OF THE DRAWINGS

FIG. 1 is a perspective view illustrating a state in which a contact detection module according to the present invention is installed in a cutting lathe;

FIG. 2 is a side view illustrating a state in which a precision tool tip and an object to be processed are in contact with each other in the lathe of FIG. 1;

FIG. 3 is a view illustrating a state in which a first conductive layer is formed at a distal end of the precision tool tip in the lathe of FIG. 2;

FIG. 4 is a view illustrating a state in which the object to be processed and the precision tool tip are spaced apart from each other in the lathe of FIG. 1;

FIG. 5 is a view illustrating a state in which the precision tool tip is moved to the object to be processed by a separate transfer means and comes into contact with the object to be processed, in the lathe of FIG. 4;

FIG. 6 is a view illustrating a state in which an electric signal is varied by contact between the precision tool tip and the object to be processed, in the lathe of FIG. 1;

FIG. 7 is a view illustrating a state in which the first conductive layer and a second conductive layer are peeled off as the object to be processed is processed by the precision tool tip of FIG. 1; and

FIG. 8 is a view illustrating a process of detecting contact between the precision tool tip and the object to be processed using the contact detection module installed in the lathe of FIG. 1.

### BEST MODE FOR THE INVENTION

Exemplary embodiments of a contact detection module for detecting contact between an object to be processed and a precision tool tip and a contact detection method using the same according to the present invention will be described with reference to the accompanying drawings. However, this is not for limiting the present invention to specific forms but for helping more clear understanding through the present embodiment.

Further, in description of the present embodiment, the same elements are designated by the same names and the same reference numerals, and additional description according thereto will be omitted.

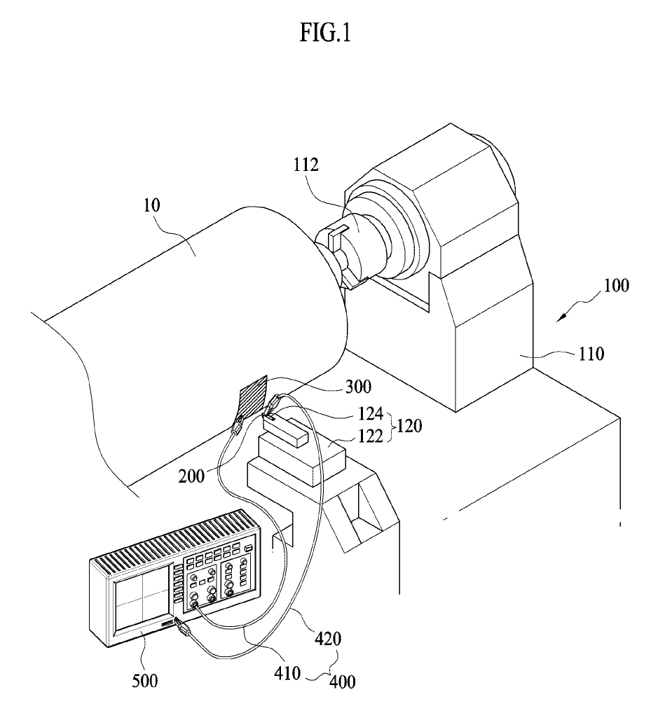

First, a configuration of the module for detecting contact between the object to be processed and the precision tool tip according to an embodiment of the present invention will be schematically described with reference to FIGS. 1 to 3.

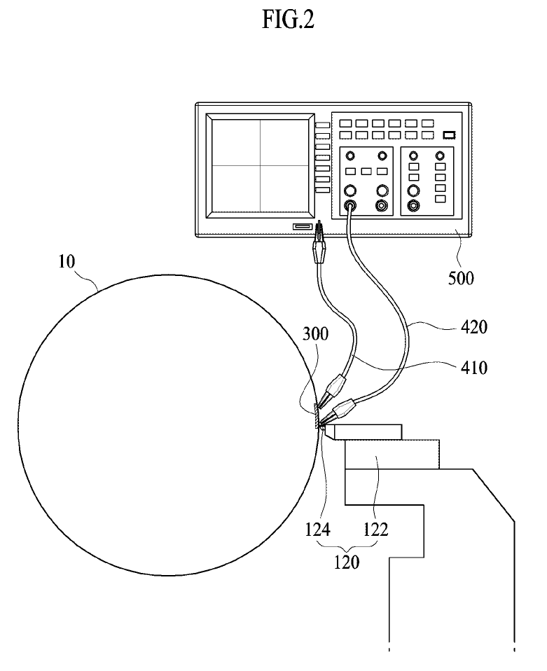

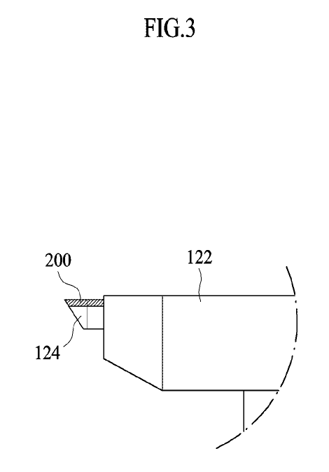

FIG. 1 is a perspective view illustrating a state in which a contact detection module according to the present invention is installed in a cutting lathe, FIG. 2 is a side view illustrating a state in which a precision tool tip and an object to processed are in contact with each other in the lathe of FIG. 1, and FIG. 3 is a view illustrating a state in which a first conductive layer is formed at a distal end of the precision tool tip, in the lathe of FIG. 2.

As illustrated, the contact detection module according to an embodiment of the present invention is applied to a general cutting lathe 100 and is configured such that an object to be processed 10 is formed in a roll mold and is processed while a precision tool tip 124 is in contact with an outer peripheral surface of the object to be processed 10.

Here, a lathe 100 used in the present invention is a device using a precision tool tip 124 configured to form fine patterns in the object to be processed 10 in nano-units, and whether a distal end of the precision tool tip 124 and the object to be processed 10 are in contact with each other may not be visually determined.

Accordingly, description of embodiments of the present invention will be made with respect to the cutting lathe 100 in which the contact detection module for detecting contact between the object to be processed 10 and the precision tool tip 124 is installed.

First, in description of an embodiment of the lathe 100 to which the contact detection module according to the present invention is applied, the lathe 100 is configured such that the precision tool tip 124 comes into contact with the object to be processed 10 having a form of a roll mold to form a constant pattern, and includes a lathe body 110 having a pair of chucks 112 seated on the object to be processed having a form of a roll mold to rotate the object to be processed 10 and a processing module 120 provided on the lathe body 110 to cut the object to be processed 10 while being in contact with the object to be processed 10.

Here, the lathe body 110 is configured such that both ends of the object to be processed 10 are coupled and supports the object to be processed 10 such that a pattern is formed as the object to be processed 10 is cut by the precision tool tip 124 by rotating the object to be processed 10.

Further, the object to be processed 10 is formed to have a form of a roller having a cylindrical shape and is cut by allowing the precision tool tip 124 to come into contact with a processing area, in a state in which the processing area is formed on an outer peripheral surface of the object to be processed 10.

In this way, the lathe body 110 is configured to support the object to be processed 10 having a form of a roller and to selectively rotate the same.

Meanwhile, the processing module 120 is coupled to the body 122 on one side thereof and is in contact with the processing area located on the outer peripheral surface of the object to processed 10, at a distal end of the other side thereof, to perform cutting. Here, because the processing module 120 processes the object to be processed 10 while being in contact with the object to be processed 10, a portion of the processing module 120, which is in contact with the processing area, is formed of a material having a larger strength than the outer peripheral surface of the object to be processed 10 and also having high wear resistance.

The processing module 120 includes a body 122 and a precision tool tip 124. The body 122 is coupled to the lathe 100 and protrudes toward the object to be processed 10.

Here, the body 122 supports the precision tool tip 124 such that a contact state in which the precision tool tip 124 is stably in contact with the object to be processed 10 may be maintained.

In the present embodiment, a location of the body 122 is transversely adjusted in the front-rear direction toward to the object to be processed 10, and accordingly, a location of the precision tool tip 124 may be adjusted together.

The precision tool tip 124 is selectively detachably coupled to the body 122 and is fixedly coupled to one distal end of the processing module 120, which protrudes toward to the object to be processed 10, to come into contact with the processing area of the object to be processed 10. Here, the precision tool tip 124 may be formed of a material that is different from that of the body 122, and a portion of the precision tool tip 124, which is in contact with the object to be processed 10, is formed of a material having a higher strength than that of the object to be processed 10.

That is, the processing module 120 includes the body 122 and the precision tool tip 124, so that the body 122 is not in contact with the object to be processed 10 and the precision tool tip 124 protrudes from the body 122 toward the object to be processed 10 to come into contact with the object to be processed 10.

Various configurations may be applied to coupling between the body 122 and the precision tool tip 124, and when the precision tool tip 124 is worn or damaged, the precision tool tip 124 may be replaced.

The processing area, which indicates a portion of the outer peripheral surface of the object to be processed 10, is an area in which the object to be processed 10 is cut by the precision tool tip 124 as the object to be processed 10 is rotated.

In this way, in the lathe body 110 according to the present invention, the processing area of the object to be processed 10 may be cut by fixing and rotating the object to be processed 10, and at the same time, by adjusting a location of the precision tool tip 124.

Meanwhile, the contact detection module according to the present invention mainly includes a first conductive layer 200, a conductive unit 400 and a detection unit 500.

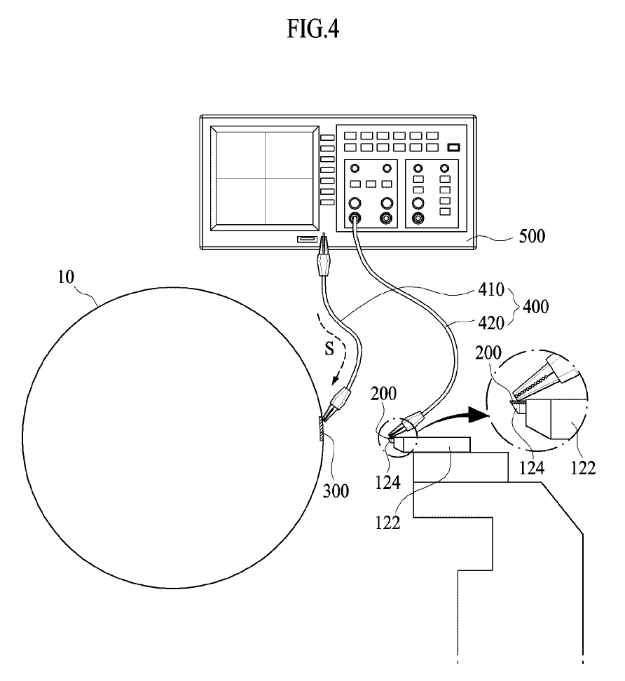

The first conductive layer 200 is applied to an area of the precision tool tip 124, which is at least in contact with the object to be processed 10 and performs processing, and is configured such that an electric signal S (see FIG. 4) may flow therethrough.

In general, the precision tool tip 124 has a distal end formed of diamond having high wear resistance, which is a material having low conductivity. Further, in this way, because the distal end of the precision tool tip 124 is formed of a material having low conductivity, the first conductive layer 200 is formed at the distal end.

Here, the first conductive layer 200 has a form of a thin film, is applied to the distal end of the precision tool tip 124, is in contact with the object to be processed 10 and is peeled off by friction when the processing starts.

In the present embodiment, the first conductive layer 200 is formed of platinum and is applied to the distal end of the precision tool tip 124 to form a conductive layer.

Meanwhile, the conductive unit 400 has a pair of general electric wires through which the electric signal S may flow. In the present embodiment, the conductive unit 400 includes a first conductive line 410 connected to the object to be processed 10, through which the electric signal S may flow, and a second conductive line 420 connected to the first conductive layer 200, through which the electric signal S may flow.

In the present embodiment, the first conductive line 410 and the second conductive line 420 are coupled to the object to be processed 10 and the first conductive layer 200, respectively, and is connected to the detection unit 500 which will be described below.

That is, the conductive unit 400 is configured such that the first conductive line 410 is connected to the object to be processed 10 and the second conductive line 420 is connected to the first conductive layer 200 so that the electric signal S generated by the detection unit 500 may flow therethrough.

In this way, the first conductive line 410 and the second conductive line 420 are configured such that one sides thereof are connected to the object to be processed 10 and the first conductive layer 200, respectively, and the other sides thereof are connected to the detection unit 500.

Meanwhile, the detection unit 500 includes a signal generation unit (not illustrated) configured to generate an electric signal S to transmit the electric signal S to the conductive unit 400 and a detection unit (not illustrated) configured to measure the electric signal S transferred through the conductive unit 400 and detect a change in the electric signal S.

Further, whether the object to be processed 10 and the precision tool tip 124 are in contact with each other is determined depending on a change in the electric signal S detected by the detection unit.

In detail, the signal generation unit is connected to the other side of at least one of the first conductive line 410 and the second conductive line 420 to supply the electric signal S. In the present embodiment, the signal generation unit is connected to the second conductive line 420 to transfer current to the first conductive layer 200.

Meanwhile, the detection unit is connected to the other side of the first conductive line 410 to measure the electric signal S transferred from the object to be processed 10 and detect whether the electric signal S is changed.

That is, the detection unit 500 supplies current to the first conductive layer 200 connected to the second conductive line 420 through the signal generation unit, and at the same time, measures the current transferred through the first conductive line 410.

Accordingly, when the object to be processed 10 and the precision tool tip 124 are in contact with each other, the current transferred to the first conductive layer 200 along the second conductive line 420 is moved to the object to be processed 10 to flow to the first conductive line 410.

Further, in this way, when the current flows to the first conductive line 410, the detection unit may determine whether the object to be processed 10 and the precision tool tip 124 are in contact with each other, by detecting the current.

That is, the current may flow to the entire conductive unit 400 as the object to be processed 10 and the precision tool tip 124 are in contact with each other, and accordingly, the detection unit determines whether the object to be processed 10 and the precision tool tip 124 are in contact with each other, by detecting the current transferred through the first conductive line 410,

In the present invention, in the detection unit 500, the signal generation unit and the detection unit may be integrally formed or may be separately formed. In the present embodiment, as illustrated, the detection unit 500 is a mechanism such as an oscilloscope and is thus configured such that the signal generation unit and the detection unit are integrally formed.

Of course, unlike this, the signal generation unit and the detection unit may be separately formed.

In this way, in the contact detection module for detecting contact between the object to be processed 10 and the precision tool tip 124 according to the present invention, the conductive unit 400 is connected to the object to be processed 10 and the precision tool tip 124 and a state in which the current may flow through the entire conductive unit 400 is made by the contact between the object to be processed 10 and the precision tool tip 124, so that whether the object to be processed 10 and the precision tool tip 124 are in contact with each other may be determined.

Meanwhile, in the present embodiment, when the object to be processed 10 is not formed of a conductive material, the contact detection module according to the present invention may further include a separate second conductive layer 300.

In the present embodiment, the object to be processed 10 is formed of a non-conductive material, and accordingly, as illustrated, the contact detection module further includes the second conductive layer 300.

The second conductive layer 300 is applied to one surface or the entire surface of the object to be processed 10, which is to be processed, such that the electric signal S may flow therethrough when the second conductive layer 300 is in contact with the first conductive layer 200.

Here, a portion of the second conductive layer 300 is applied to the processing area of the object to be processed 10, which is processed while being in contact with the precision tool tip 124, so that a thin film that may be easily peeled off when the object to be processed 10 is processed later while being in contact with the precision tool tip 124 may be formed.

In this way, when the second conductive layer 300 is further provided in the object to be processed 10, the first conductive line 410 is connected to the second conductive layer 300.

That is, in the conductive unit 400, the first conductive line 410 is connected to the second conductive layer 300 and the second conductive line 420 is connected to the first conductive layer 200.

In this way, the conductive unit 400 is connected to the first conductive layer 200 and the second conductive layer 300. Accordingly, when the object to be processed 10 and the precision tool tip 124 are in contact with each other, the first conductive layer 200 and the second conductive layer 300 come into contact with each other, so that the electric signal S may flow through the entire conductive unit 400.

Meanwhile, the second conductive layer 300 may be applied only to a portion of the object to be processed 10, which is in contact with the precision tool tip 124, or unlike this, may be applied to the entire surface of the object to be processed 10.

In this way, the contact detection module according to the present invention further includes the second conductive layer 300, so that even when the object to be processed 10 is formed of a non-conductive material, whether the object to be processed 10 and the precision tool tip 124 are in contact with each other may be stably determined.

Of course, even when the object to be processed 10 is formed of a conductive material, the second conductive layer 300 may be provided to reduce a difference between conductivities of the object to be processed 10 and the first conductive layer 200.

In the present embodiment, the second conductive layer 300 is formed of the same material as that of the first conductive layer 200 to receive the electric signal S generated by the signal generation unit through the first conductive layer 200, and accordingly, a reduction in the intensity of the electric signal S by a difference between materials of the first conductive layer 200 and the second conductive layer 300 may be prevented.

Of course, unlike this, the second conductive layer 300 and the first conductive layer 200 may be formed of different materials.

That is, the first conductive layer 200 and the second conductive layer 300 may be removed when the object to be processed 10 is processed while the precision tool tip 124 and the object to be processed 10 are in contact with each other, and may be formed of any material that is conductive such that an electric signal is transferred therethrough.

In this way, the contact detection module according to the present invention includes the first conductive layer 200, the second conductive layer 300, and the conductive unit 400 and the detection unit 500, wherein the detection unit 500 determines whether the object to be processed 10 and the precision tool tip 124 are in contact with each other by detecting whether the electric signal S flows through the entire conductive unit 400.

Further, in this way, as a zero point of the precision tool tip 124 is set in a state in which the contact between the precision tool tip 124 and the object to be processed 10 is detected through the contact detection module, fine patterns may be processed in the object to be processed 10 by adjusting a location of the precision tool tip 124 later.

Next, a state in which the contact detection module according to the present invention determines whether the object to be processed 10 and the precision tool tip 124 are in contact with each other will be described with reference to FIGS. 4 to 6.

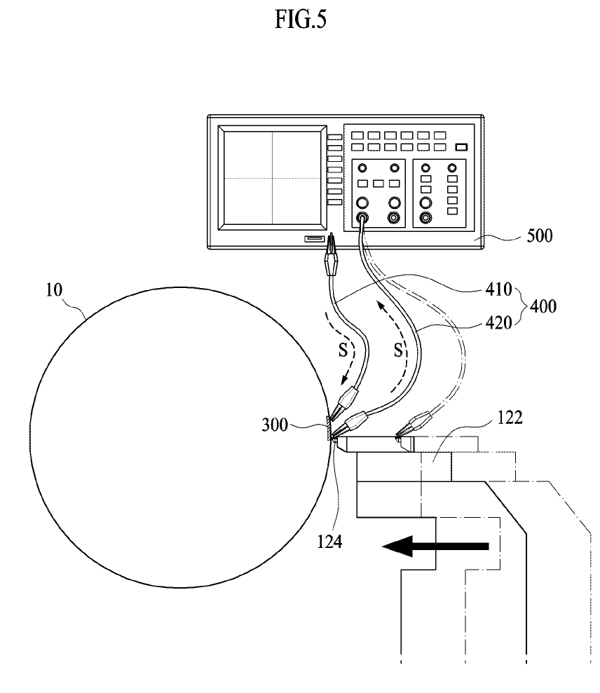

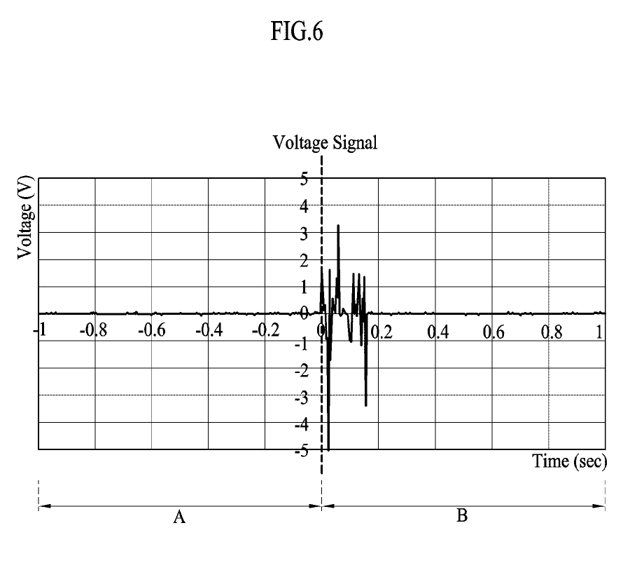

FIG. 4 is a view illustrating a state in which the object to be processed 10 and the precision tool tip 124 are spaced apart from each other in the lathe 100 of FIG. 1, FIG. 5 a view illustrating a state in which the precision tool tip 124 is moved toward the object to be processed 10 by a separate transfer means (not illustrated) and is in contact with the object to be processed 10, in the lathe 100 of FIG. 4, and FIG. 6 is a view illustrating a state in which the electric signal S is varied by the contact between the precision tool tip 124 and the object to be processed 10, in the lathe 100 of FIG. 1.

First, referring to FIG. 4, in the lathe 100, the object to be processed 10 and the precision tool tip 124 are spaced apart from each other, one side of the second conductive line 420 is connected to the first conductive layer 200, and one side of the first conductive line 410 is connected to the second conductive layer 300 applied to the precision tool tip 124.

Further, the other side of the second conductive line 420 is connected to the signal generation unit and the other side of the first conductive line 410 is connected to the detection unit.

In this configuration, because the first conductive layer 200 and the second conductive layer 300 are spaced apart from each other even when the signal generation unit transfers the electric signal S to the first conductive layer 200 through the second conductive line 420, the electric signal S fails to be transferred to the second conductive layer 300.

In this case, as illustrated in FIG. 6, a signal detected by the detection unit is illustrated as area A.

Here, the signal illustrated in FIG. 6 indicates voltage measured by supplying current to the second conductive line 420 and receiving the current transferred through the first conductive line 410 in a state in which the detection unit 500 is an oscilloscope.

In this way, in a state in which the object to be processed 10 and the precision tool tip 124 are spaced apart from each other, because the electric signal S fails to be transferred to the second conductive layer 300 even when the electric signal S is supplied to the first conductive layer 200, the electric signal S detected by the detection unit is not changed.

However, as illustrated in FIG. 5, when the object to be processed 10 and the precision tool tip 124 come into contact with each other, the electric signal S supplied by the signal generation unit is transferred to the detection unit via the second conductive line 420, the first conductive layer 200, the second conductive layer 300 and the first conductive line 410.

In this case, after the electric signal S supplied along the second conductive line 420 passes through the entire conductive unit 400, the detection unit receives the electric signal S.

That is, the conductive unit 400 is conducted as the first conductive layer 200 and the second conductive layer 300 come into contact with each other, and accordingly, after the electric signal S supplied by the signal generation unit passes through the first conductive layer 200, the second conductive layer 300 and the conductive unit 400, the detection unit receives the electric signal S.

Accordingly, the electric signal S detected by the detection unit is illustrated as area B illustrated in FIG. 6.

In this way, in the contact detection module according to the present invention, whether the electric signal S flows through the entire conductive unit 400 is adjusted depending on whether the object to be processed 10 and the precision tool tip 124 are in contact with each other, and accordingly, the electric signal S detected by the detection unit is varied as illustrated in FIG. 6.

Because of this, even if a user may not visually observe the contact between the precision tool tip 124 and the object to be processed 10, whether the precision tool tip 124 is in contact with the object to be processed 10 may be identified.

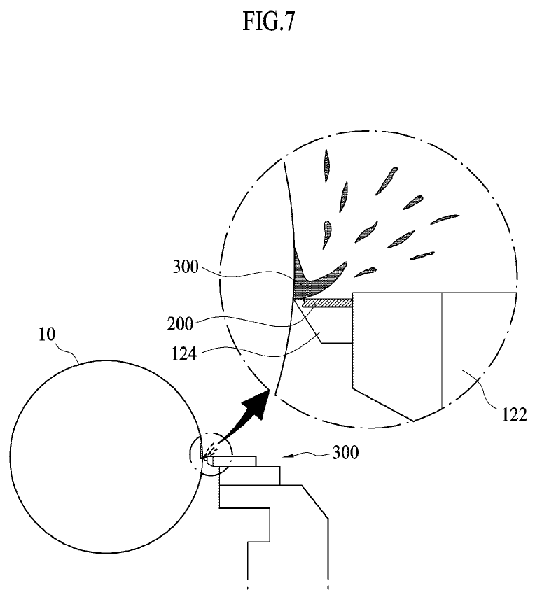

Next, FIG. 7 is a view illustrating a state in which the first conductive layer 200 and the second conductive layer 300 according to the present invention are separated during cutting.

FIG. 7 is a view illustrating a state in which the first conductive layer 200 and the second conductive layer 300 are peeled off as the object to be processed 10 is processed by the precision tool tip of FIG. 1.

As illustrated, the first conductive layer 200 and the second conductive layer 300 according to the present invention are applied to areas of the precision tool tip 124 and the object to be processed 10, which are in contact with each other, in a form of a thin film, and accordingly, is easily peeled off by mutual friction when the object to be processed 10 is processed in a state in which the precision tool tip 124 is in contact with the object to be processed 10.

In this way, the first conductive layer 200 and the second conductive layer 300 are peeled off, and thus, do not affect cutting patterns processed in the object to be processed 10.

That is, because the first conductive layer 200 and the second conductive layer 300 are thinly applied to the object to be processed 10 and the precision tool tip 124, respectively, and are immediately peeled off and separated when the object to be processed 10 is cut, an interference when the precision tool tip 124 processes the object to be processed 10 does not substantially occur.

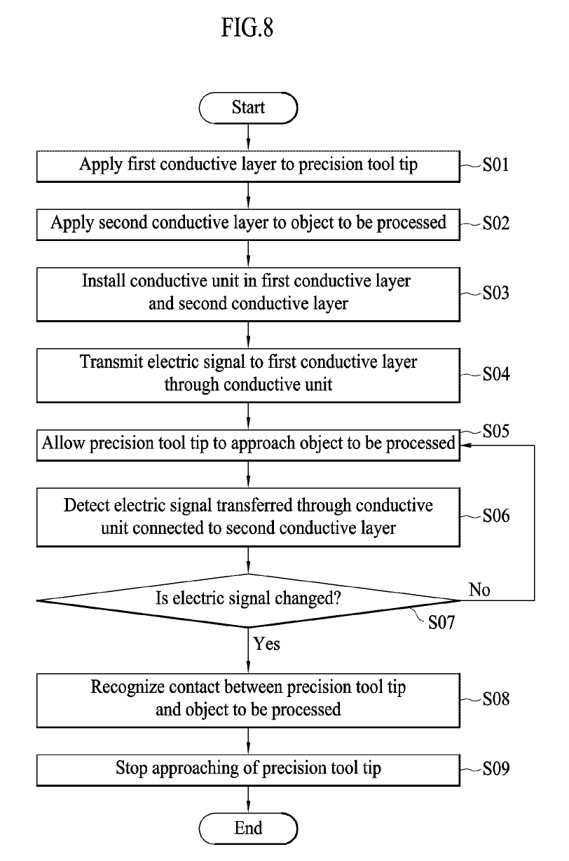

Next, a method for detecting contact between the object to be processed 10 and the precision tool tip 124 using the above-described contact detection module will be described with reference to FIG. 8.

FIG. 8 is a view illustrating a process of detecting the contact between the precision tool tip 124 and the object to be processed 10 using the contact detection module installed in the lathe of FIG. 1.

First, in description of the method for detecting whether the object to be processed 10 and the precision tool tip 124 are in contact with each other using the contact detection module according to the present invention, a step (S01) of coating the first conductive layer 200 through which the electric signal S flows to a surface of the precision tool tip 124 is performed.

Here, the first conductive layer 200 is formed of a conductive material, is applied to an area of the precision tool tip 124, which is in contact with the object to be processed 10, and in the present embodiment, is formed of platinum.

Further, a step (S02) of coating the second conductive layer 300 through which the electric signal S flows to the object to be processed 10 is performed.

Likewise, the second conductive layer 300 is also formed of a conductive material and may be applied to a surface of the object to be processed 10 or may be applied to a partial area of the object to be processed 10, which is in contact with the precision tool tip 124.

In the present embodiment, the second conductive layer 300 may be formed of the same material as that of the first conductive layer 200, or unlike this, may be formed of a material that is different from that of the first conductive layer 200.

Thereafter, a step (S03) of installing the conductive unit 400 in the first conductive layer 200 and the second conductive layer 300 is performed. Here, the conductive unit 400 includes the second conductive line 420 connected to the first conductive layer 200 and the first conductive line 410 connected to the second conductive layer 300, and is configured such that each conductive line may transfer the electric signal.

In the present embodiment, the first conductive line 410 and the second conductive line 420 are electric wires, one sides thereof are connected to the second conductive layer 300 and the first conductive layer 200, respectively, and the other ones thereof are connected to the detection unit and the signal generation unit, respectively.

Thereafter, a step (S04) of transmitting the electric signal S to the second conductive layer 300 through the conductive unit 400 is performed.

Here, in the conductive unit 400, the other sides of the first conductive line 410 and the second conductive line 420 are connected to the oscilloscope, and whether the electric signal S flows through the entire conductive unit 400 is determined through the oscilloscope.

Accordingly, because the object to be processed 10 and the precision tool tip 124 are spaced apart from each other, current may not flow between the first conductive layer 200 and the second conductive layer 300.

Next, a step of allowing the precision tool tip 124 to approach the object to be processed 10 is performed (S05).

Further, a step of detecting the electric signal S transferred through the conductive unit 400 connected to the second conductive layer 300 is performed (S06).

This is to detect a change in the electric signal S detected by the oscilloscope while sequentially passing through the first conductive layer 200 and the object to be processed 10, and whether the object to be processed 10 and the precision tool tip 124 are in contact with each other is determined through a change in the intensity of the detected electric signal S (S07).

When the change in the electric signal S is not detected by the oscilloscope, the precision tool tip 124 and the object to be processed 10 are not in contact with each other, and thus, the precision tool tip 124 is continuously moved to the object to be processed 10.

However, when the change in the electric signal S received by the oscilloscope is detected, it is determined that the precision tool tip 124 and the object to be processed 10 are in contact with each other (S08).

In this way, when the contact between the precision tool tip 124 and the object to be processed 10 is recognized, the precision tool tip 124 stops to approach the object to be processed 10 (S09).

Through this process, whether the precision tool tip 124 and the object to be processed 10 are in contact with each other may be detected through the contact detection module according to the present invention.

Accordingly, as in the present invention, there is an advantage in that when the object to be processed 10 and the precision tool tip 124 are in contact with each other, an electric signal is generated, so that the precision tool tip 124 and the object to be processed 10 automatically comes into contact with each other using an electric signal generated without manipulation of a user as a trigger.

Hereinabove, the exemplary embodiments of the present invention have been described above. The present invention may be specified in different specific forms without departing from the purpose and the scope of the present invention, in addition to the above-described embodiments. Therefore, the present embodiment is configured to be not restrictive but illustrative, and accordingly, the present invention is not limited to the above descriptions and may be changed within the scope and equivalents of the appended claims.

1. A contact detection module for detecting whether a precision tool tip and an object to be processed are in contact with each other in a lathe in which the object to be processed is cut using the precision tool tip, the contact detection module comprising:
a first conductive layer applied to an area of the precision tool tip, which performs processing while being at least in contact with the object to be processed;
a conductive unit comprising a first conductive line connected to the object to be processed, through which an electric signal flows, and a second conductive line connected to the first conductive layer, through which the electric signal flows; and
a detection unit comprising a signal generation unit configured to supply the electric signal to at least one of the first conductive line and the second conductive line and a detection unit provided in the conductive unit to detect whether the electric signal flows through the entire conductive unit, and configured to determine whether the object to be processed and the precision tool tip are in contact with each other, based on a change in the electric signal detected by the detection unit.

2. The contact detection module of claim 1, further comprising a second conductive layer which is applied to one surface or an entire surface of the object to be processed, which is to be processed, and through which the electric signal flows when the second conductive layer is in contact with the first conductive layer.

3. The contact detection module of claim 2, wherein the second conductive layer is formed only in an area of the object to be processed, which is in contact with the precision tool tip.

4. The contact detection module of claim 2, wherein the second conductive layer is formed of the same material as that of the first conductive layer.

5. The contact detection module of claim 2, wherein the first conductive layer and the second conductive layer are removed by mutual friction when the precision tool tip cuts the object to be processed.

6. The contact detection module of claim 1, wherein the first conductive layer is applied only to an area of the precision tool tip, which is in contact with the object to be processed.

7. A contact detection method for detecting whether a precision tool tip and an object to be processed are in contact with each other in a lathe in which the object to be processed is cut using the precision tool tip, the contact detection method comprising:
coating a first conductive layer through which an electric signal flows, to a surface of the precision tool tip;
installing a separate conductive unit connected to the first conductive layer and the object to be processed to transfer an electric signal;
transferring the electric signal to at least one of the object to be processed and the first conductive layer;
allowing the precision tool tip to approach the object to be processed;
detecting a change in the electric signal detected by sequentially passing through the first conductive layer and the object to be processed, by the conductive unit; and
determining whether the precision tool tip and the object to be processed are in contact with each other, based on the change in the electric signal detected by the conductive unit.

8. The contact detection method of claim 1, wherein the first conductive layer is applied only to an area of the precision tool tip, which is in contact with the object to be processed.

9. The contact detection method of claim 1, wherein the conductive unit comprises:
a first conductive line connected to the object to be processed, through which the electric signal flows; and
a second conductive line connected to the first conductive layer, through which the electric signal flows.

10. The contact detection method of claim 7, further comprising coating a second conductive layer through which the electric signal flows, to the object to be processed.
